(19) United States
(12) Patent Application Publication
(10) Pub. No.: US 2005/0002626 A1
(43) Pub. Date: Jan. 6, 2005

(54) Photonic crystal fiber, light controller, projector, and method of manufacturing photonic crystal fiber

(76) Inventors: Makoto Watanabe, Miyagi (JP); Atsushi Fukumoto, Kanagawa (JP); Michio Oka, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/834,981

(22) Filed: Apr. 30, 2004

(30) Foreign Application Priority Data
May 23, 2003 (JP) P2003-146740

(51) Int. Cl. G02B 6/20

(52) U.S. Cl. 385/125; 385/80

(57) ABSTRACT

A photonic crystal fiber has a configuration in which a multiplicity of voids are arranged along the longitudinal direction of the fiber and with a regular sectional structure, a terminal end portion of the fiber is fusion bond sealed with a fusing material composed of a glass lower than a light propagation medium of the fiber in softening temperature, and the terminal end portion is connected to a ferrule with the fusing material. With this configuration, it is possible to obviate the lowerings in optical characteristics such as a large refractive index difference between the light propagation medium and the voids, a high light transmission efficiency, a high numerical aperture, etc., and to obviate such problems as the penetration of foreign matter into the inside of the voids, a burning failure arising from a positional staggering of the ferrule, etc.

### BACKGROUND OF THE INVENTION

The present invention relates to a photonic crystal fiber, a light controller, a projector, and a method of manufacturing a photonic crystal fiber, specifically to an optical fiber with the so-called photonic crystal structure in which a multiplicity of voids are arranged in a light propagation medium in the state of being extended along the longitudinal direction of the optical fiber, a light controller and a projector which each include the optical fiber, and a method of manufacturing the photonic crystal fiber.

In an optical fiber in which propagation of light energy and amplification of light are performed, a connection part called ferrule is joined to the fiber end.

The joining of the ferrule is ordinarily conducted by use of an organic adhesive. In this case, however, there have been a problem as to heat resistance, problems such as secular change, and, hence, a problem as to reliability.

As a countermeasure against the above problems, there has been proposed a method in which a holed ferrule provided, for example, with a V-shaped groove in its side surface is used, an optical fiber is disposed in and along the groove, and the ferrule and the fiber are fused to each other at their circumferential surfaces using a glass having a low softening temperature (see, for example, Japanese Patent Laid-open No. Hei 6-109944 (FIG. 2, paragraph No. [0003]).

Meanwhile, in recent years, attendant on the remarkable progress of optical digital communication, optical communications in great capacity and over long distances on a scale of several tens of kilometers have been conducted vigorously.

In this case, there is need for optical fibers having a light transmission efficiency as high as possible and a high numerical aperture. As an optical fiber of this type, there has been developed a fiber with a photonic crystal structure, i.e., a photonic crystal fiber.

The photonic crystal fiber has a configuration in which fine voids with a diameter of several micrometers or below surround the periphery of the so-called core portion of a light propagation medium composed, for example, of quartz, whereby a large variation in refractive index distribution is provided in the diametral direction, to obtain a high transmission efficiency and a high numerical aperture of not less than 0.5, for example.

On the other hand, in the long-distance high-capacity optical communications mentioned above, optical fiber amplifiers for amplifying optical signals without conversion of the optical signals into electrical signals have come to be used widely.

In the optical fiber amplifiers, also, there has been proposed an optical fiber amplifier having the above-mentioned photonic crystal fiber configuration which promises a high light transmission efficiency and a high numerical aperture.

Besides, the demand for a high light transmission efficiency and a high numerical aperture has been increased not only in the optical communication field but also in the filed of projectors and the like for which a high light intensity is desired.

In the optical fiber for conducting the light energy propagation and light amplification, light with a high output of not less than several watts is inputted and outputted through an optical fiber end, so that special care is required in fixation of the optical fiber end, from the viewpoint of safety.

Therefore, it is inappropriate to use the above-mentioned holed ferrule designed for fusion onto a circumferential side surface of the fiber. Besides, also in the case of using a normal ferrule not provided with a hole such as a V-shaped groove in its side surface, when an organic adhesive is used, the secular change of the adhesive causes the ferrule to be positionally staggered by an amount of several to several tens of micrometers, resulting in that the high-output light to be introduced into the fiber end portion leaks from the core, namely, the light propagation medium. Generation of heat attendant on the leakage of light would lead to a safety problem such as a breakage of the device including the fiber.

In addition, in the photonic crystal fiber, the voids are opening at the fiber end face, so that moisture or contaminants in air may penetrate through the openings into the voids. The penetration of moisture or contaminants generates a variation in refractive index distribution in the diametral direction of the fiber, whereby it is made impossible to maintain the intrinsic light transmission efficiency, the performance is lowered, and propagation characteristics and numerical aperture are degraded or varied, thereby lowering the reliability.

In view of this, in the photonic crystal fiber, it is necessary to seal the opening ends at the void end portion.

The sealing is carried out, for example, by a technique in which the void end portion is collapsed by heating only the end portion to a temperature of not less than 1600° C., which is the melting point of the quartz glass constituting the propagation medium of the optical fiber, for example, a temperature of 2000° C. by arc discharge.

Where this technique is used, however, the terminal end of the optical fiber is deformed, which generates such inconveniences as, for example, a distortion in the intensity distribution of the light outputted from the fiber.

In addition, in the optical fiber amplifier configuration mentioned above, a double structure is adopted in which a core composed of a gain medium for propagating incident light, for example, signal light and for amplifying the input light by excitation of excitation light is provided in a propagation medium for propagating the excitation light. In this case, also, generation of a strain in the core structure leads to the generation of a distortion in the intensity distribution of the output light, resulting in, for example, a lowering in the light transmission efficiency at a joint portion between this optical fiber and other optical fiber.

### SUMMARY OF THE INVENTION

It is an object of the present invention to solve the above-mentioned problems concerning the terminal end of an optical fiber having the photonic crystal structure.

According to the first aspect of the present invention, there is provided a photonic crystal fiber which includes a ferrule disposed at a terminal end portion of a photonic crystal fiber member including a multiplicity of voids arranged in a light propagation medium in the state of being extended along the longitudinal direction of the fiber, wherein

the terminal end of the photonic crystal fiber, inclusive of an end face of the terminal end portion, is fusion bond sealed with a glass fusing material lower than the light propagation medium in melting point and transmissive to the light introduced into the photonic crystal fiber member, and

the ferrule is attached to the photonic crystal fiber member by the glass fusion bonding, and opening ends of the voids opening at the end face of the terminal end portion of the photonic crystal fiber member are sealed by the glass fusion bonding.

According to the second aspect of the present invention, there is provided a method of manufacturing a photonic crystal fiber, which includes the steps of:

disposing a ferrule at a terminal end portion of a photonic crystal fiber member including a multiplicity of voids arranged in a light propagation medium of an optical fiber in the state of being extended along the longitudinal direction of the fiber, and

fusion bond sealing the terminal end portion of the photonic crystal fiber member, inclusive of an end face of the terminal end portion, with a glass fusing material lower than the light propagation medium in melting point and transmissive to the light introduced into the photonic crystal fiber member, wherein

the ferrule is attached to the photonic crystal fiber member by fusion of the glass fusing material, and opening ends of the voids opening at the end face of the terminal end portion of the photonic crystal fiber member are sealed by fusion of the glass fusing material.

According to the third aspect of the present invention, there is provided a light controller which includes:

a light source portion, and

a light modulation device including an arrangement of light diffraction elements composed of micro-ribbons and varying the quantity of diffracted light by displacements of the light diffraction elements, wherein

the light source portion includes a light oscillator, and a photonic crystal fiber,

the photonic crystal fiber includes a ferrule disposed at a terminal end portion of a photonic crystal fiber member including a multiplicity of voids arranged in a light propagation medium in the state of being extended along the longitudinal direction of the fiber,

a glass fusing. material lower than the light propagation medium in melting point and transmissive to the light introduced into the photonic crystal fiber member is fused to the terminal end portion of the photonic crystal fiber member inclusive of an end face of the terminal end portion, the ferrule is attached to the photonic crystal fiber member by fusion of the glass fusing material, and opening ends of the voids opening at the end face of the terminal end portion of the photonic crystal fiber member are sealed by fusion of the glass fusing material, and

light from the light oscillator is introduced into the photonic crystal fiber, light is radiated from the photonic crystal fiber to the light modulation device, and the quantity of diffracted light is controlled by displacements of the micro-ribbons of the modulation device.

According to the fourth aspect of the present invention, there is provided a projector which includes:

a light source portion, and

a light modulation device including an arrangement of light diffraction elements composed of micro-ribbons and varying the quantity of diffracted light by displacements of the light diffraction elements, wherein

the light source portion includes a light oscillator, and a photonic crystal fiber,

the photonic crystal fiber includes a ferrule disposed at a terminal end portion of a photonic crystal fiber member including a multiplicity of voids arranged in a light propagation medium in the state of being extended along the longitudinal direction of the fiber,

a glass fusing material lower than said light propagation medium in melting point and transmissive to the light introduced into the photonic crystal fiber member is fused to the terminal end portion of the photonic crystal fiber member inclusive of an end face of the terminal end portion, the ferrule is attached to the photonic crystal fiber member by fusion of the glass fusing material, and opening ends of the voids opening at the end face of the terminal end portion of the photonic crystal fiber member are sealed by fusion of the glass fusing material, and

light from the light oscillator is introduced into the photonic crystal fiber, light is radiated from the photonic crystal fiber to the light modulation device, and the quantity of diffracted light is controlled by displacements of the micro-ribbons of the modulation device, so as thereby to form a projected optical image.

In the photonic crystal fiber according to the present invention, the terminal end portion of the fiber member is sealed by glass fusion bonding, so that it is possible to obviate the secular change which would occur where an organic adhesive is used. Therefore, it is possible to effectively obviate a positional stagger of the ferrule.

In addition, since the glass fusion bonding is conducted by use of a glass which is lower than the light propagation medium in melting temperature, deformation and/or distortion of the core portion in the optical fiber member as well as the distortion of intensity distribution of output light, which would occur due to high-temperature heating in the case of using a quartz glass, can be obviated, and the output light having an appropriate light intensity distribution can be maintained.

Further, since the end face of the terminal end portion of the fiber is sealed, it is possible to obviate the problem intrinsic of the photonic crystal fiber, i.e., the problem that moisture and the like would penetrate into the inside of the voids through the opening ends of the voids. Therefore, the photonic crystal fiber can stably display its performance for a long time without spoiling the intrinsic characteristics thereof, i.e., a high light transmission efficiency and a high numerical aperture.

In addition, the photonic crystal fiber according to the present invention and a light amplification fiber using the same can maintain the high light transmission efficiency, the high numerical aperture, and hence the high light intensity possessed by the fiber member. Therefore, in the light controller and the projector according to the present invention which use this configuration, light control and projection can be performed efficiently and stably.

According to the method of manufacturing a photonic crystal fiber of the present invention, the purpose of sealing the voids at the end face of the terminal end portion of the photonic crystal fiber can be accomplished, simultaneously with the purpose in the case of using an organic adhesive according to the related art, i.e., the purpose of simply adhering the fiber member and the ferrule to each other.

Besides, the light controller and the projector according to the present invention are excellent in the above-mentioned characteristics, and can perform stable light propagation by the photonic crystal fiber, so that it is possible to achieve assured light control and projection.

### BRIEF DESCRIPTION OF THE DRAWINGS

The above and other objects, features and advantages of the present invention will become apparent from the following description and appended claims, taken in conjunction with the accompanying drawings, in which:

FIG. 1 is a schematic vertical sectional view of an essential part of one embodiment of a photonic crystal fiber according to the present invention;

FIG. 2 is a schematic front view, as viewed from an end face of a terminal end portion of a photonic crystal fiber member, of one embodiment of the photonic crystal fiber according to the present invention;

FIG. 3 is a schematic front view, as viewed from the end face of the terminal end portion of the photonic crystal fiber member, of another embodiment of the photonic crystal fiber according to the present invention;

FIG. 4 is a schematic step diagram illustrating a part of one embodiment of a method of manufacturing a photonic crystal fiber according to the present invention;

FIG. 5 schematically shows the constitution of one example of an apparatus for evaluating the reliability of the photonic crystal fiber according to the present invention;

FIG. 6 schematically shows the constitution of one example of an apparatus for evaluating the light amplification performance of the photonic crystal fiber according to the present invention;

FIGS. 7A and 7B schematically show the constitutions of embodiments of a light controller using the photonic crystal fiber according to the present invention;

FIG. 8 schematically shows the constitution of one embodiment of a light modulation device used in the light controller according to the present invention;

FIG. 9 is a schematic perspective view of one example of a diffraction grating structure constituting the light modulation device used in the light controller according to the present invention;

FIG. 10 is a schematic illustration of the principle of generating primary diffracted light, in the diffraction grating structure constituting the light modulation device used in the light controller according to the present invention; and

FIG. 11 schematically shows the constitution of one embodiment of a projector including the light controller using the photonic crystal fiber according to the present invention.

### DETAILED DESCRIPTION OF THE PREFERRED EMBODIMENTS

Now, embodiments of a photonic crystal fiber, a light controller, a projector, and a method of manufacturing a photonic crystal fiber according to the present invention will be described below. It should be understood that the present invention naturally is not limited to the embodiments.

First, an embodiment of the photonic crystal fiber according to the present invention will be described.

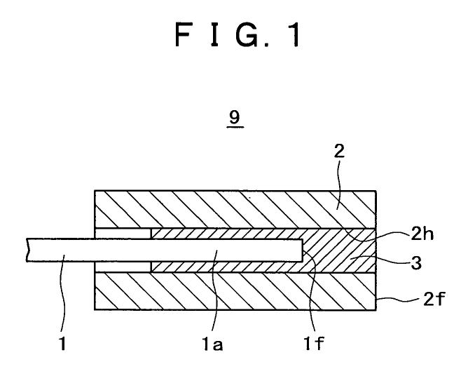

FIG. 1 is a schematic vertical sectional view of an essential part of a photonic crystal fiber 9 according to the present invention.

The photonic crystal fiber 9 includes a photonic crystal fiber member 1, and a ferrule 2 attached to a terminal end portion 1a of the fiber member 1. The ferrule 2 is composed, for example, of a tubular body provided with a through-hole 2h in its center.

The terminal end portion 1a of the fiber member 1 is inserted into the through-hole 2h of the ferrule 2, and is so disposed that an end face 1f of the terminal end portion 1a is located in the through-hole 2h on the inner side relative to an opening end 2f of the through-hole 2h.

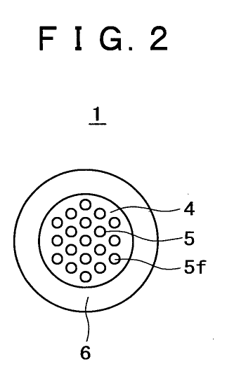

The fiber member 1 and the ferrule 2 are fusion bonded to each other in such a manner that opening ends 5f of voids 5 (shown in FIG. 2) at the terminal end portion 1a of the fiber member 1 are sealed with a glass fusing material 3, for example, a lead-based glass or a non-lead-based bismuth glass which is lower than a light propagation medium of the fiber member 1 and the ferrule 2 in melting point.

First Embodiment of Photonic Crystal Fiber Member

In this embodiment, as shown in FIG. 2, a multiplicity of voids 5 are arranged in a light propagation medium 4 composed of quartz with an outside diameter of 125 μm, for example, in the state of being extended along the longitudinal direction of the fiber, and are arranged regularly with predetermined positional relationships in the cross section thereof having a diameter of about 5 μm, for example, i.e. in a section orthogonal to the longitudinal direction of the fiber. In other words, as viewed from the side of the light propagation medium 4, most of the propagation medium 4 is disposed with its periphery surrounded by the voids, so that a large refractive index distribution, or refractive index difference, is generated in the diametral direction of the fiber member 1.

In addition, the fiber member 1 is coated with a protective layer 6 composed, for example, of an acrylic resin on the circumferential surface thereof.

Next, as a second embodiment, an embodiment of a photonic crystal fiber member including a gain medium at a part of a propagation medium and having a light amplifying effect on input light, for example, signal light will be described.

Second Embodiment of Photonic Crystal Fiber Member

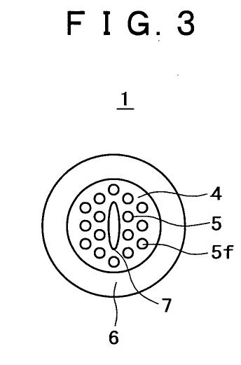

In this embodiment, as a schematic front view as viewed from the end face 1f of the terminal end portion 1f of a photonic crystal fiber member 1 including a gain medium is shown in FIG. 3, a core portion of a gain medium 7 doped with a rare earth ion, for example, erbium (Er) ion or neodium (Nd) ion to have a light amplifying effect for exciting and emitting light with a predetermined wavelength by excitation light with a predetermined wavelength is arranged in a central portion of a light propagation medium 4 composed, for example, of quartz of the fiber member 1 in the state of being extended along the longitudinal direction of the fiber.

Propagation of light is performed while incident light, for example, signal light is amplified by the gain medium 7.

The core portion of the gain medium 7 may be elliptic in sectional shape with a major diameter of about 8 μm and a minor diameter of about 3 μm, for example. The core portion of the gain medium 7 may be composed of a quartz glass to which, for example, neodium (Nd) ions for generating amplified light with a central wavelength of about 1064 nm by excitation light and aluminum (Al) ions or germanium (Ge) ions for regulation of refractive index have been added.

In addition, in the surrounding of the core portion, a multiplicity of voids 5 with a diameter of about 5 μm are arranged in the surrounding of the propagation medium of a non-gain medium composed only of the quartz glass.

Besides, in this embodiment also, the multiplicity of voids 5 arranged regularly with predetermined positional relationships in a section orthogonal to the longitudinal direction of the fiber so as to have a refractive index distribution, or refractive index difference, in the section are arranged in the state of being extended along the longitudinal direction of the fiber.

In addition, the fiber member 1 is coated with a protective layer 6 composed, for example, of an acrylic resin on the circumferential surface thereof.

Embodiment of Method of Manufacturing Photonic Crystal Fiber

A ferrule 2 is attached to the terminal end portion 1a of the above-mentioned photonic crystal fiber member 1.

The photonic crystal fiber member 1 has an outside diameter of about 125 μm and a length of about 6 m, for example.

The ferrule 2 may be composed of a superhigh-density light-transmitting sintered alumina body having an inside diameter of about 127 μm, an outside diameter of about 1.3 mm, and a length of about 3 mm, for example.

The ferrule 2 is composed, for example, of quartz or superhigh-density alumina, and assumes the shape of a tubular body such as a hollow cylindrical body, a polygonal-section tubular body, etc. provided with a through-hole 2h in its center.

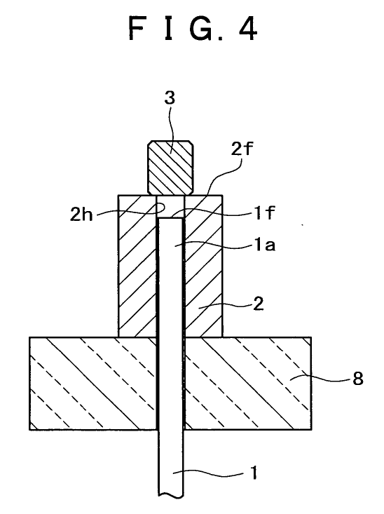

As for example a schematic vertical sectional view is shown in FIG. 4, the terminal end portion 1a of the fiber member 1 is inserted into the through-hole 2h of the ferrule 2, and the assembly is mounted on and fixed to a heat-insulating body 8 serving as a base for performing a fusion bonding operation thereon. In this case, the end face 1f of the terminal end portion 1a of the fiber member 1 is prevented from projecting from the end face 2f of the ferrule 2.

Next, a glass fusing material 3, for example, a lead-based glass or a non-lead-based bismuth glass having been drawn into a bar-like shape is placed on a central area of the end face 2f of the ferrule 2.

The drawn fusing glass 3 may have a diameter of about 220 μm, and, for example, about 30 mg of the drawn fusing glass 3 may be used. The fusing glass may have a softening temperature of about 560° C., for example, and the working temperature therefor may be about 620° C., for example.

In this condition, the ferrule 2 is heated, for example, to about 650° C. for 30 min by use of, for example, a small-type heater (not shown) so as to melt the glass fusing material 3, and the molten glass fusing material 3 is permitted to flow into the ferrule 2, thereby filling the gap between the through-hole 2h and the fiber member 1 with the molten glass fusing material 3 to a depth of 2 mm, for example, from the end face 2f of the ferrule 2. Thus, the ferrule 2 is fusion bonded and fixed to the terminal end portion 1a of the fiber member 1, and all opening ends 5f of all voids 5 in the fiber member 1 are sealed gas-tight.

In addition, the molten glass fusing material 3 is permitted to flow into the voids in the fiber member 1 to a depth of about 300 μm, for example, from the end face 1f of the terminal end portion 1a of the fiber member 1.

The terminal end face 2f of the ferrule 2 treated as above was subjected to optical polishing by use of a tip polisher for optical fiber.

The photonic crystal fiber of the present invention according to first embodiment, produced as above, was subjected to evaluation of reliability as an optical fiber.

Evaluation of Reliability

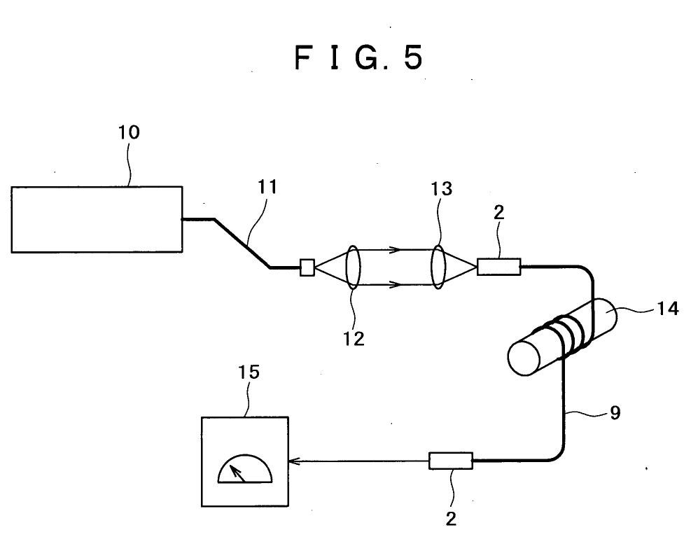

The evaluation method will be described. FIG. 5 schematically shows the constitution of an evaluation apparatus used here. As shown in the figure, the evaluation apparatus includes a photonic crystal fiber 9 according to the first embodiment of the present invention, as a specimen to be evaluated, an excitation-light light source 10 composed, for example, of a semiconductor laser, a light transmission cable 11, a collimator lens 12, a condenser lens 13, a winding coil 14 on which the photonic crystal fiber 9 of the present invention is wound, and a light output meter 15.

Laser light with a central wavelength of about 807 nm and an output of about 18 W. for example, from the excitation-light light source 10 is inputted into the light transmission cable 11, then passed through the collimator lens 12 and the condenser lens 13, and inputted into the photonic crystal fiber 9 of the present invention through the terminal end portion thereof.

In this reliability evaluation, the excitation light incident on the terminal end portion of the photonic crystal fiber 9 of the present invention from the condenser lens 13 is inputted, with its spot diameter regulated to about 50 μm, for example, so that leakage of light is generated when the excitation light is incident on the photonic crystal fiber 9 of the present invention which has a diameter of about 40 μm, for example.

Under this condition, the light output from the photonic crystal fiber 9 of the present invention was measured by the light output meter 15, to be about 14 W, which indicates a leakage of output of about 3 W taking into account the portion lost by reflection.

The system was operated continuously for 2 hr in this configuration, upon which the photonic crystal fiber 9 of the present invention showed no particular change, and the value of the outgoing light output showed no large variation.

On the other hand, when a specimen produced by attaching an optical fiber to a ferrule by use of a conventional adhesive was subjected to the same evaluation as above, the adhered portion was burned about 5 min after the start of operation of the excitation-light light source 10, and the outgoing light output from the conventional optical fiber was lowered to 0.5 W.

The above results clearly show that the use of the photonic crystal fiber 9 according to the present invention makes it possible to enhance reliability and to enhance resistance to leakage of light at the incidence of high-output light on the optical fiber end, and is suitable for transmission of optical energy.

Next, the photonic crystal fiber of the present invention according to second embodiment was evaluated as to light amplification performance.

Evaluation of Light Amplification Performance

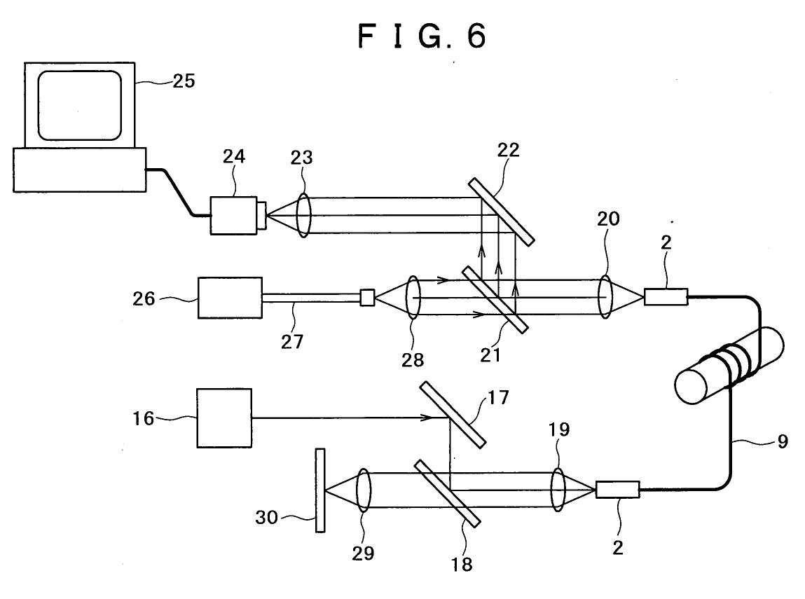

The evaluation method will be described. FIG. 6 schematically shows the constitution of an evaluation apparatus used here. The evaluation apparatus includes a photonic crystal fiber 9 of the present invention, an input light source, i.e., a signal light source 16, a mirror 17, a dichroic mirror 18, a condenser lens 19, a collimator lens 20, a dichroic mirror 21, a mirror 22, a condenser lens 23, an image pickup device 24, and a beam analyzer 25. In addition, the apparatus includes a pumping-light light source, i.e., an excitation-light light source 26, a cable 27 for transmitting the pumping light from the pumping-light light source, and a collimator lens 28. Further, the apparatus includes a condenser lens 29 and a mirror 30 on the opposite side of the condenser lens 19 with respect to the dichroic mirror 18.

In the above configuration, light amplification is evaluated.

First, signal light with a central wavelength of about 1064 nm, a pulse width of 5 nanoseconds with an interval of 2 MHz, and a maximum output of 0.2 W, for example, outputted from the signal light source 16 is reflected respectively by the mirror 17 and the dichroic mirror 18, and is condensed by the condenser lens 19, to be incident on a terminal end portion on one side of the light-amplifying photonic crystal fiber 9 of the present invention.

On the other hand, pumping light with a central wavelength of 807 nm, for example, outputted from the pumping-light light source 26 is transmitted through the pumping-light guide cable 27, the collimator lens 28 and the condenser lens 20, to be incident on the photonic crystal fiber 9.

In this instance, in the photonic crystal fiber 9 of the present invention, the above-mentioned gain medium 7 is excited, whereby excitation is caused to amplify the light with the wavelength of about 1064 nm, for example. The amplified light is transmitted through the collimator lens 20, the dichroic mirror 21, the mirror 22, and the condenser lens 23, to be introduced into the image pickup device 24, and the resulting image pickup light is analyzed by the beam analyzer 25.

In this case, a part of the pumping light incident on the photonic crystal fiber 9 of the present invention is collimated by the condenser lens 19, is transmitted through the dichroic mirror 18, is condensed by the condenser lens 29, and is reflected by the mirror 30, to be again incident on the photonic crystal fiber 9, thereby exciting the gain medium 7.

In this configuration, the intensity distribution of the light having undergone the light amplification by the photonic crystal fiber 9 of the present invention was observed on the beam analyzer 25, upon which an intensity distribution conforming to Gaussian distribution could be obtained.

On the other hand, when a photonic crystal fiber produced by sealing the voids through melting by arc discharge based on the above-mentioned conventional method was used, the intensity distribution of amplified light was asymmetric.

Next, an embodiment of a light controller having the photonic crystal fiber structure according to the present invention will be described.

Embodiment of Light Controller

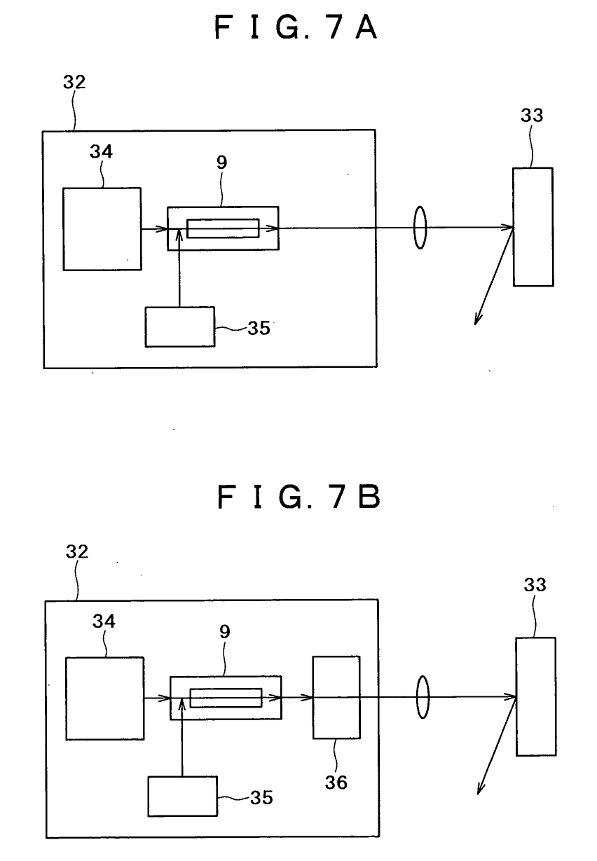

In this embodiment, as a schematic illustration of the constitution of a light controller is shown in FIG. 7A, the light controller includes a light source portion 32 and a light modulation device 33.

The light source portion 32 includes an input light source 34, a light-amplifying photonic crystal fiber 9, and an excitation-light light source (pumping-light light source) 35.

In this configuration, input light from the light source portion 32 is introduced into the photonic crystal fiber 9; on the other hand, excitation light from the excitation-light light source 35 composed, for example, of a semiconductor laser is introduced into the optical fiber 9, for amplifying the input light, and the amplified light is introduced into the light modulation device 33.

In another embodiment, as a schematic illustration of the constitution of a light controller is shown in FIG. 7B, a waveform conversion device (SHG: Secondary Harmonic Generator) 36 composed of a non-linear optical device is provided. In FIG. 7B, the portions corresponding to those in FIG. 7A are denoted by the same symbols as used above, and description thereof is omitted.

In this case, amplified light from the above-mentioned photonic crystal fiber 9 is subjected to waveform conversion by the waveform conversion device 36. For example, input light with a central wavelength of about 1064 nm from the input light source 34 is inputted into the photonic crystal fiber 9, is excited by excitation light with a central wavelength of about 807 nm, for example, coming from the excitation-light light source, and the light with the central wavelength of about 1064 nm, for example, is inputted from the fiber 9 into the wavelength conversion device 36, whereby green light with a central wavelength of about 532 nm as secondary harmonic wave is obtained from the light source portion 32.

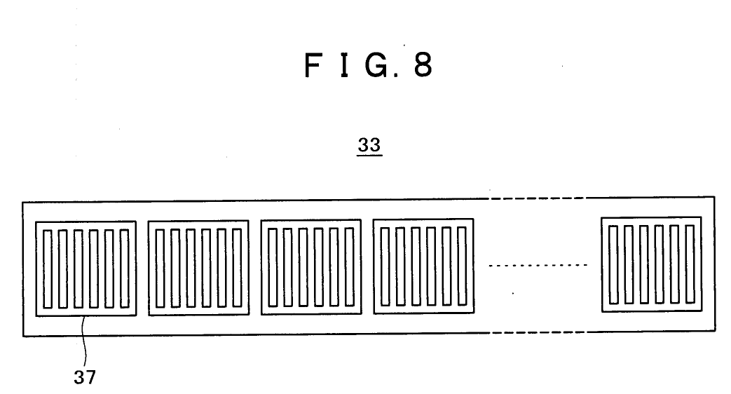

FIG. 8 is a schematic plan view of the light modulation device 33. As shown, the light modulation device 33, for example, the so-called GLV (Grating Light Valve) included of an arrangement of light diffraction elements composed of micro-ribbons has a structure in which a multiplicity of pixels 37 each included of an arrangement of the diffraction gratings composed of the micro-ribbons are arrayed in a one-dimensional manner.

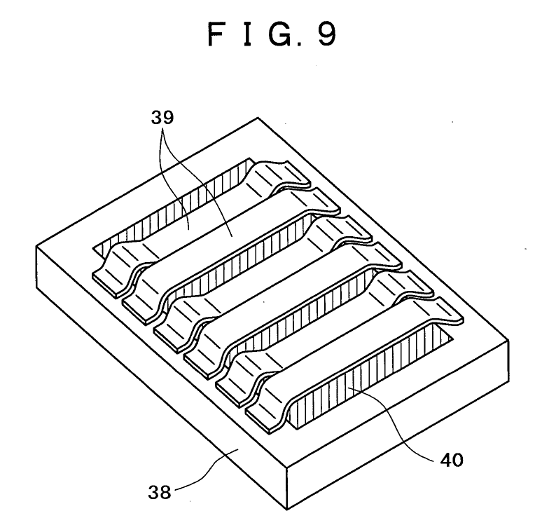

FIG. 9 is a schematic perspective view of the internal structure of the pixel 36. As shown, the pixel 36 has an internal structure in which, for example, six laser light-reflective micro-ribbons 39 each supported at both ends thereof are arranged in parallel to each other on a substrate 38, to constitute a diffraction grating.

On the other hand, under and across the array of the micro-ribbons 39, a common counter electrode 40 is formed on the substrate 38 oppositely to all the micro-ribbons 39, with a required spacing therebetween.

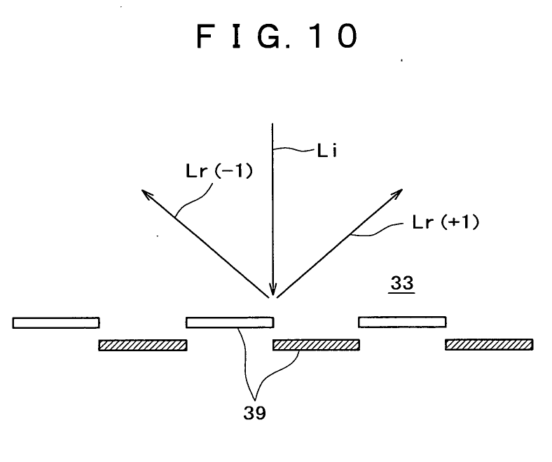

When a required voltage is impressed between, for example, every other one of the micro-ribbons 39 and the counter electrode 40, the central portions of the relevant micro-ribbons 39 are shifted to and held at a predetermined distance from the substrate 38; as shown in a schematic sectional view in FIG. 10, when incident light Li, or the light from the light source portion 32 in FIG. 7, is inputted to the micro-ribbons 39 in each pixel, primary diffracted light beams Lr (−1) and Lr (+1) are generated.

In this manner, the light from the light source portion 32 is modulated by the light modulation device 33 into the presence or absence of or intensity (gradation) of ±1 primary diffracted light beams.

Next, an embodiment of a projector including the photonic crystal fiber according to the present invention will be described.

Embodiment of Projector

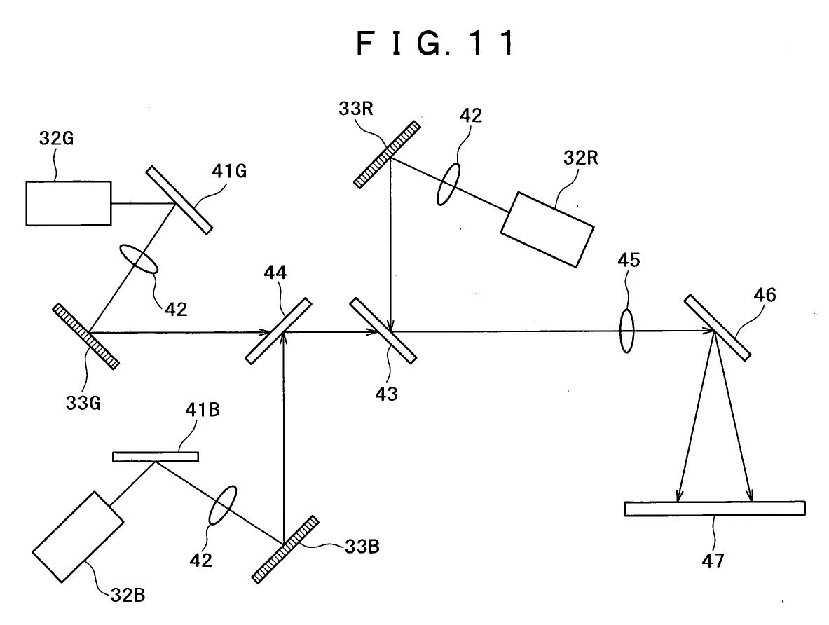

In this embodiment, as a schematic illustration of the constitution of a projector is shown in FIG. 11, the projector includes light source portions 32R, 32G, 32B for obtaining red, green and blue light beams, and light modulation devices 33R, 33G, 33B composed, for example, GLVs provided correspondingly to the light source portions for obtaining red, green and blue one-dimensional projection optical images, respectively. The one-dimensional optical images are synthesized by dichroic mirrors 43 and 44, and a two-dimensional image is projected on a screen 47 by a scanner 46. The light source portions 32R and 32B each have the configuration shown in FIG. 7A, while the light source portion 32G has the configuration shown in FIG. 7B. The projector further includes a reflector 41, a condenser lens 42, and a projection lens 45.

The photonic crystal fiber, the light controller, the projector, and the method of manufacturing the photonic crystal fiber according to the present invention are not limited to the above-described embodiments, and various changes or modifications are possible within the scope of the present invention.

1. A photonic crystal fiber which comprises a ferrule disposed at a terminal end portion of a photonic crystal fiber member comprising a multiplicity of voids arranged in a light propagation medium in the state of being extended along the longitudinal direction of said fiber, wherein
said terminal end of said photonic crystal fiber, inclusive of an end face of said terminal end portion, is fusion bond sealed with a glass fusing material lower than said light propagation medium in melting point and transmissive to the light introduced into said photonic crystal fiber member, and
said ferrule is attached to said photonic crystal fiber member by said glass fusion bonding, and opening ends of said voids opening at said end face of said terminal end portion of said photonic crystal fiber member are sealed by said glass fusion bonding.

2. A photonic crystal fiber as set forth in claim 1, wherein a gain medium for exciting and emitting light with a predetermined wavelength by excitation light is provided at least at a part of said light propagation medium.

3. A photonic crystal fiber as set forth in claim 1, wherein said light propagation medium is quartz.

4. A photonic crystal fiber as set forth in claim 2, wherein said gain medium in said light propagation medium is a rare earth-doped light propagation medium.

5. A photonic crystal fiber as set forth in claim 1, wherein said glass fusing material is a lead-based glass or non-lead-based bismuth glass which is lower than said light propagation medium in melting point.

6. A photonic crystal fiber as set forth in claim 1, wherein said ferrule is composed of quartz glass or superhigh-density alumina.

7. A method of manufacturing a photonic crystal fiber, which comprises the steps of:
disposing a ferrule at a terminal end portion of a photonic crystal fiber member comprising a multiplicity of voids arranged in a light propagation medium of an optical fiber in the state of being extended along the longitudinal direction of said fiber, and
fusion bond sealing said terminal end portion of said photonic crystal fiber member, inclusive of an end face of said terminal end portion, with a glass fusing material lower than said light propagation medium in melting point and transmissive to the light introduced into said photonic crystal fiber member, wherein
said ferrule is attached to said photonic crystal fiber member by fusion of said glass fusing material, and opening ends of said voids opening at said end face of said terminal end portion of said photonic crystal fiber member are sealed by fusion of said glass fusing material.

8. A method of manufacturing a photonic crystal fiber as set forth in claim 7, wherein said photonic crystal fiber comprises a gain medium at least at a part of said light propagation medium, said gain medium being for exciting and emitting light with a predetermined wavelength by excitation light.

9. A light controller which comprises:
a light source portion, and
a light modulation device comprising an arrangement of light diffraction elements composed of micro-ribbons and varying the quantity of diffracted light by displacements of said light diffraction elements, wherein
said light source portion comprises a light oscillator, and a photonic crystal fiber,
said photonic crystal fiber comprises a ferrule disposed at a terminal end portion of a photonic crystal fiber member comprising a multiplicity of voids arranged in a light propagation medium in the state of being extended along the longitudinal direction of said fiber,
a glass fusing material lower than said light propagation medium in melting point and transmissive to the light introduced into said photonic crystal fiber member is fused to said terminal end portion of said photonic crystal fiber member inclusive of an end face of said terminal end portion, said ferrule is attached to said photonic crystal fiber member by fusion of said glass fusing material, and opening ends of said voids opening at said end face of said terminal end portion of said photonic crystal fiber member are sealed by fusion of said glass fusing material, and
light from said light oscillator is introduced into said photonic crystal fiber, light is radiated from said photonic crystal fiber to said light modulation device, and the quantity of diffracted light is controlled by displacements of said micro-ribbons of said modulation device.

10. A light controller as set forth in claim 9, wherein a gain medium for exciting and emitting light with a predetermined wavelength by excitation light is provided at least at a part of said light propagation medium.

11. A projector which comprises:
a light source portion, and
a light modulation device comprising an arrangement of light diffraction elements composed of micro-ribbons and varying the quantity of diffracted light by displacements of said light diffraction elements, wherein
said light source portion comprises a light oscillator, and a photonic crystal fiber,
said photonic crystal fiber comprises a ferrule disposed at a terminal end portion of a photonic crystal fiber member comprising a multiplicity of voids arranged in a light propagation medium in the state of being extended along the longitudinal direction of said fiber,
a glass fusing material lower than said light propagation medium in melting point and transmissive to the light introduced into said photonic crystal fiber member is fused to said terminal end portion of said photonic crystal fiber member inclusive of an end face of said terminal end portion, said ferrule is attached to said photonic crystal fiber member by fusion of said glass fusing material, and opening ends of said voids opening at said end face of said terminal end portion of said photonic crystal fiber member are sealed by fusion of said glass fusing material, and
light from said light oscillator is introduced into said photonic crystal fiber, light is radiated from said photonic crystal fiber to said light modulation device, and the quantity of diffracted light is controlled by displacements of said micro-ribbons of said modulation device, so as thereby to form a projected optical image.

12. A projector as set forth in claim 11, wherein a gain medium for exciting and emitting light with a predetermined wavelength by excitation light is provided at least at a part of said light propagation medium.
